(19) United States
(12) Patent Application Publication
(10) Pub. No.: US 2017/0288294 A1
(43) Pub. Date: Oct. 5, 2017

(54) ACTIVE BASE-TRACKING MULTI-ANTENNA SYSTEM AND ACTIVE BASE-TRACKING ANTENNA SYSTEM FOR VESSEL AND OFFSHORE STRUCTURE

(71) Applicant: HARBORMAX CO., LTD, Busan (KR)

(72) Inventors: Hee-wook KANG, Busan (KR); Ji-song KIM, Busan (KR)

(73) Assignee: HARBORMAX CO., LTD, Busan (KR)

(21) Appl. No.: 15/314,325

(22) PCT Filed: Oct. 18, 2016
(86) PCT No.: PCT/KR2016/011680

§ 371 Date: Nov. 28, 2016

(30) Foreign Application Priority Data
Oct. 22, 2015 (KR) 10-2015-0147102
Jan. 14, 2016 (KR) 10-2016-0004540

(51) Int. Cl. H01Q 1/24; H01Q 3/08; H01Q 21/06; H01Q 3/02; H01Q 1/34; B63B 45/04

(52) U.S. Cl. CPC H01Q 1/22; H01Q 1/34; B63B 45/04; H01Q 21/06; H01Q 3/02; H01Q 3/08

(57) ABSTRACT

An active base-tracking multi-antenna system and an active base-tracking antenna system for a vessel and an offshore structure are provided. The active base-tracking multi-antenna system may include: a fixing shaft fixed to a fixture on a vessel or an offshore structure; a gimbal unit disposed on a top of the fixing shaft and keep positions of a panning motor and antennas; the panning motor disposed on the gimbal unit and simultaneously rotating the antennas in a left-right direction; and the antennas connected to the panning motor. Therefore, it is possible to always keep the antennas in a stable horizontal position and greatly improve communication quality by adjusting the azimuths and vertical angles of the antennas in real time to an optimal state for communication with a base station.

### BACKGROUND OF THE INVENTION

### 1. Field of the Invention

The present invention relates to an active base-tracking multi-antenna system and an active base-tracking antenna system for a vessel and an offshore structure and, more particularly, to allow a tracking antenna to rotate at optical azimuths always in a stable position regardless of movement of a vessel or an offshore structure.

### 2. Description of the Related Art

In general, maritime communication is increasingly required for 4S (Ship-Ship, Ship-Shore) communication with modernization of GMDSS (Global Maritime Distress and Safety System) and the strategy of developing e-Navigation.

Further, a requirement of mass data communication has increased, including the increase in the requirement of providing internet access even in vessels at sea, a requirement of changing an analog type into a digital type, and a requirement of changing voice communication into data communication in maritime communication similar to terrestrial wireless communication that has already rapidly developed.

In order to modernize maritime communication, there was a study of developing a digital VHF wireless communication system based on ITU-R M.1842-1, but the communication coverage of this system has difficulty in providing a service requiring a broad band of a maximum transmission speed 307.2 kbps (ITU-R M.1842-1 Annex4) within 120 km.

Recently, communication devices (SeaFi Horizon) that can perform Wi-Fi within 12 km from the seashore have been commercially developed and are used for the provision of internet and video conferencing in vessels, remote monitoring on vessels from land, and communication with weather systems at sea, and various plans for increasing a transmission range to use maritime communication in other fields have been studied.

An “Apparatus and Method of directional antenna tracking in maritime broadband wireless communication” has been disclosed in Patent Document 1 (Korea Patent Application No. 1020140158290).

The directional antenna tracking apparatus of Patent Document 1 includes an antenna activator and an activation controller. The antenna activator obtains signals from a plurality of antennas arranged at regular intervals to cover all directions in 360 degrees of azimuth within a transmission range, and connects, by tracking the antennas in a direction where the highest signal quality is measured, to a transmitter in order to obtain signals and establish a communication link. The activation controller analyzes the obtained signals to determine the direction from which the highest signal quality is measured and from the analysis of the obtained signals creates information including signal quality information and location information of a receiver. Then, the activation controller transmits a control signal to the antenna activator to position the direction of the antennas included in the antenna activator on the basis of the created information, so that tracking is in the direction where the highest signal quality is measured.

The apparatus of directional antenna tracking in Patent Document 1 uses directional antennas in a wireless communication system, particularly, a maritime wireless communication system, in which several antennas are arranged in predetermined directions according to azimuths to cover directions of 360 degrees, and connect an optimum communication link and increase the transmission range by searching and tracking an antenna direction to keep the link.

In the apparatus of directional antenna tracking in Patent Document 1, the antenna activator can perform panning to an azimuth using an actuating motor in an antenna panning unit and can perform tilting for adjusting elevation using an actuating motor in an antenna tilting unit.

FIG. 1 is a view showing movement of a ship.

As shown in FIG. 1, a ship or an offshore structure is moved by waves and accordingly, the position of an antenna fixed to the deck moves with the movement of the ship or offshore structure.

Accordingly, there is a need for a gimbal that can keep an antenna in a predetermined position for stable communication with a base station.

An “Antenna tracking gimbal system featuring continuously rotating line of sight using pitch-roll coupling” has been disclosed in Patent Document 2 (Korea Patent Application No. 1020080007594).

The antenna tracking gimbal system in Patent Document 2 includes: an antenna gimbal that tracks a moving object by receiving data from the object; a data-processing and state-displaying computer that calculates a rotational angle of the antenna gimbal and displays a state by determining the direction of the antenna gimbal by processing data from the antenna gimbal; and a control unit that transmits an activation signal to the antenna gimbal in response to a control signal according to the rotational angle calculated by the data-processing and state-displaying computer.

The antenna tracking gimbal system in Patent Document 2 is a system for tracking the location of an object such as an airplane continuously moving on the basis of data such as location information from the object, in which the antenna gimbal tracking a moving object on the basis of data from the object is operated in a way that the pitch shaft is rotated by a first servomotor and the roll shaft is rotated by a second servomotor, that is, two servomotors are used for an antenna gimbal.

### SUMMARY OF THE INVENTION

### 1. Technical Problem

Although the apparatus of directional antenna tracking in Patent Document 1 includes a panning unit for adjusting the azimuths of antennas and a tilting unit for adjusting the vertical angles of the antenna, there is no gimbal unit for keeping the antenna in a stable position, so it cannot ensure stable communication with a base station from a vessel or a offshore structure that is shaken by waves.

Further, the antenna tracking gimbal system required to precise control of two servomotors in Patent Document 2 is useful for communication with an airplane moving in the air, but is not suitable for an antenna system for a vessel and an offshore structure that is mounted on a vessel and an offshore structure that constantly moves due to waves, and transmits/receives signals to/from a terrestrial base station on land or a maritime base station.

In order to solve the problems in the related art, an object of the present invention is to provide an active base-tracking multi-antenna system and an active base-tracking antenna system for a vessel and an offshore structure, the active base-tracking multi-antenna system and the active base-tracking antenna system being mounted on a vessel or an offshore structure constantly moving due to waves and allowing antennas to connect and maintain an optimal communication link by tracking a terrestrial base station or a maritime base station by always maintaining a stable position.

### 2. Technical Solution

In order to achieve the above object, according to one aspect of the present invention, there is provided an active base-tracking multi-antenna system for a vessel and an offshore structure, the system including: a fixing shaft fixed to a fixture on a vessel or an offshore structure; a gimbal unit disposed on a top of the fixing shaft and keeping positions of a panning motor and antennas; the panning motor disposed on the gimbal unit and simultaneously rotating the antennas in a left-right direction; and the antennas connected to the panning motor.

The system may further include a rotary plate fixed to a rotary shaft of the panning motor and supporting the antennas.

The gimbal unit may keep the antennas in a stable position via a universal joint using gravity without a specific controlling or actuating unit.

The gimbal unit may include: a fixing bracket fixed to the top of the fixing shaft; a Y-axial rotation support bracket coupled to an X-axial hinge pin on the fixing bracket to freely rotate in a Y-axial direction; and an X-axial rotation support bracket coupled to an Y-axial hinge pin on the Y-axial rotation support bracket to freely rotate in an X-axial direction.

The operation of the gimbal unit may be controlled by an antenna control unit (ACU) having various items of control information, including vessel information and base station information.

The rotary plate may be formed in the shape of a cross and may support four antennas, and modern brackets for fixing the antennas may be coupled to front, rear, left, and right sides of the rotary plate, respectively.

The system may further include a tilting motor fixed to a top of the gimbal unit and adjusting vertical angles of the antennas.

The panning motor may be disposed on the tilting motor and the rotary plate may be disposed on the rotary shaft of the panning motor.

The operation of the tilting motor may be controlled by an antenna control unit (ACU) having various items of control information, including vessel information and base station information.

The tilting motor may be an outer rotor motor having a rotor around an outside of a stator, a plurality of flanges radially extending outward may be formed around an outside of the rotor; tilting hinge extensions may be coupled to joints, which are coupled to the antennas, of the rotary plate to be rotatable up and down, modern brackets may be fixed to the tilting hinge extensions, respectively, the antennas may be fixed to the modern brackets, respectively, and connection links may be disposed between coupling extensions on inner sides of the modern brackets and the flanges of the tilting motor.

In order to achieve the above object, according to another aspect of the present invention, there is provided an active base-tracking antenna system for a vessel and an offshore structure, the system including: a protective case fixed to a fixture on a vessel or an offshore structure; a gimbal unit disposed at an upper portion in the protective case and maintaining the position of an antenna; and the antenna disposed under the gimbal unit.

The active base-tracking antenna system for a vessel and an offshore structure may further include a panning motor disposed under the gimbal unit, in which the antenna may be coupled to the panning motor.

A rotary plate may be disposed on a rotary shaft of the panning motor and the antenna may be fixed to the rotary plate.

The gimbal unit may keep the antenna in a stable position by way of a universal joint using gravity without a specific controlling or actuating unit.

The gimbal unit may include: a fixing bracket fixed at an upper portion in the protective case; a Y-axial rotation support bracket coupled to an X-axial hinge pin of the fixing bracket to freely rotate in a Y-axial direction; and an X-axial rotation support bracket coupled to an Y-axial hinge pin of the Y-axial rotation support bracket to freely rotate in an X-axial direction.

The operation of the panning motor may be controlled by an antenna control unit (ACU) having various items of control information, including vessel information and base station information.

The rotary plate may be formed in a straight line shape and the antenna may be disposed at both ends of the bottom of the rotary plate.

The rotary plate may be formed in a cross shape and the antenna may be disposed at front and rear and left and right sides of a bottom of the rotary plate.

The antenna may be a directional antenna.

### 3. Advantageous Effects

According to the active base-tracking multi-antenna system and an active base-tracking antenna system for a vessel and an offshore structure of the present invention, since it is possible to always keep the antennas in a stable horizontal position using the gimbal unit that makes use of the gravity without using a specific actuating or controlling unit, it is possible to more efficiently connect and maintain a communication link with a base station.

Further, according to the active base-tracking multi-antenna system and an active base-tracking antenna system for a vessel and an offshore structure of the present invention, since the azimuths of the antennas are adjusted in real time in an optimal state for communication with a base station by the panning motor with the antennas always kept in a stable position, communication quality can be further improved.

Further, according to the active base-tracking multi-antenna system and an active base-tracking antenna system for a vessel and an offshore structure of the present invention, since the vertical angles of the antennas are adjusted in real time in an optimal state for communication with a base station by the tilting motor with the antennas always kept in a stable position, communication quality can be further improved.

### BRIEF DESCRIPTION OF THE DRAWINGS

FIG. 1 is a view showing how a ship can be moved by waves;

FIG. 2 is a perspective view of an active base-tracking multi-antenna system for a vessel and an offshore structure according to a first embodiment of the present invention;

FIG. 3 is a partial-cut front view of the active base-tracking multi-antenna system for a vessel and an offshore structure according to the first embodiment of the present invention;

FIG. 4 is a plan view of the active base-tracking multi-antenna system for a vessel and an offshore structure according to the first embodiment of the present invention;

FIGS. 5a and 5b are side views showing the operation of the active base-tracking multi-antenna system for a vessel and an offshore structure according to the first embodiment of the present invention;

FIG. 6 is a partial-cut front view of an active base-tracking multi-antenna system for a vessel and an offshore structure according to a second embodiment of the present invention;

FIG. 7 is a plan view of an active base-tracking multi-antenna system for a vessel and an offshore structure according to the second embodiment of the present invention; and

FIG. 8 is a plan view showing main parts when tilting is performed by the active base-tracking multi-antenna system for a vessel and an offshore structure according to the second embodiment of the present invention.

FIG. 9 is a perspective view of an active base-tracking antenna system for a vessel and an offshore structure according to a first embodiment of the present invention;

FIG. 10 is a front view of the active base-tracking antenna system for a vessel and an offshore structure according to the first embodiment of the present invention;

FIGS. 11a and 11b are plan views showing operation of a panning motor of the active base-tracking antenna system for a vessel and an offshore structure according to the first embodiment of the present invention;

FIGS. 12a to 12c are side views showing operation of a gimbal unit of the active base-tracking antenna system for a vessel and an offshore structure according to the first embodiment of the present invention;

FIGS. 13 and 14 are exemplary views of installation of the active base-tracking antenna system for a vessel and an offshore structure according to the first embodiment of the present invention;

FIG. 15 is a perspective view of an active base-tracking antenna system for a vessel and an offshore structure according to a second embodiment of the present invention;

FIG. 16 is a front view of the active base-tracking antenna system for a vessel and an offshore structure according to the second embodiment of the present invention;

FIG. 17 is a front view of an active base-tracking antenna system for a vessel and an offshore structure according to a third embodiment of the present invention;

FIG. 18 is a front view of the active base-tracking antenna system for a vessel and an offshore structure according to the third embodiment of the present invention;

FIG. 19 is a perspective view of an active base-tracking antenna system for a vessel and an offshore structure according to a fourth embodiment of the present invention; and

FIG. 20 is a front view of the active base-tracking antenna system for a vessel and an offshore structure according to the fourth embodiment of the present invention.

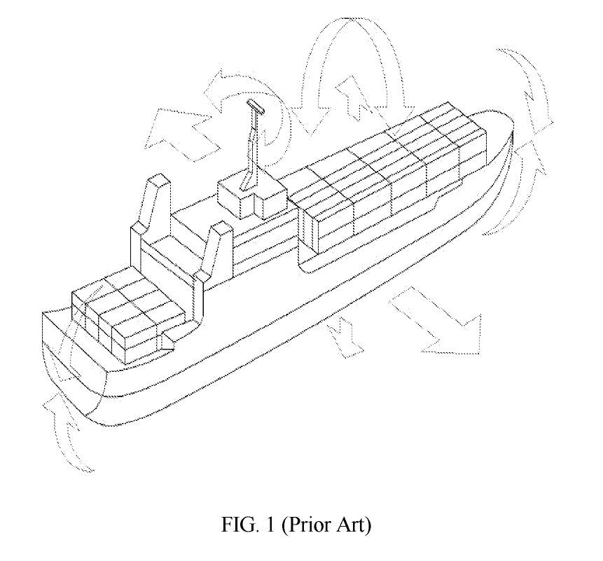

### DESCRIPTION OF THE PREFERRED EMBODIMENTS

An active base-tracking multi-antennas system for a vessel and an offshore structure according to embodiments of the present invention are described hereafter in detail with reference to the accompanying drawings.

In the following description, terms of “up”, “down”, “front”, and “rear” and other directional terms are defined on the basis of the drawings.

<Active Base-Tracking Multi-Antenna System for a Bessel and an Offshore Structure>

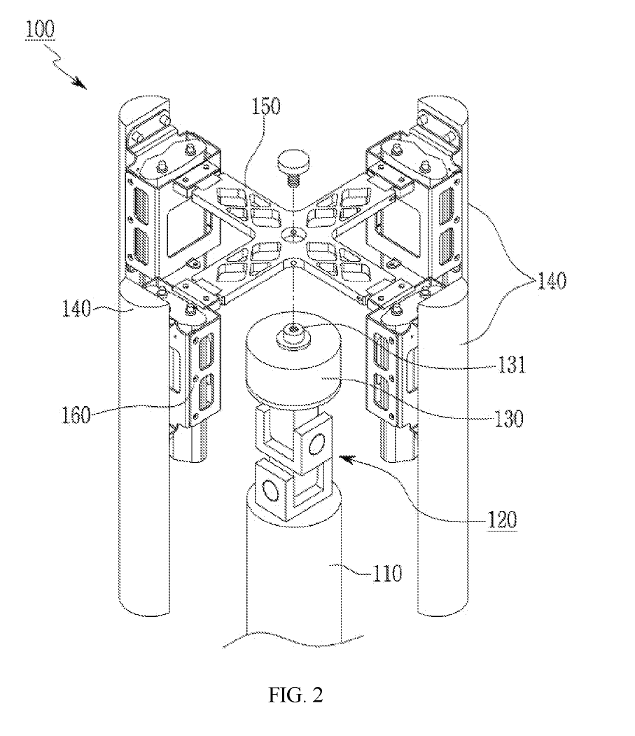

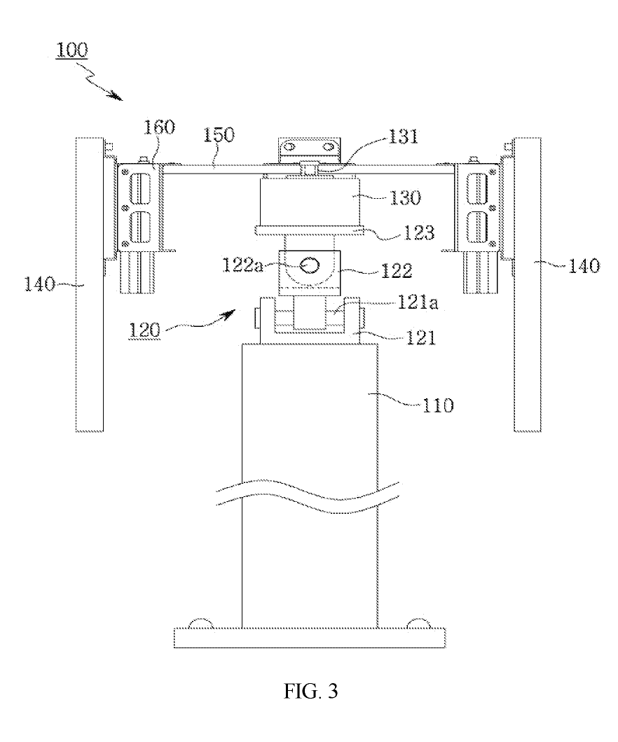

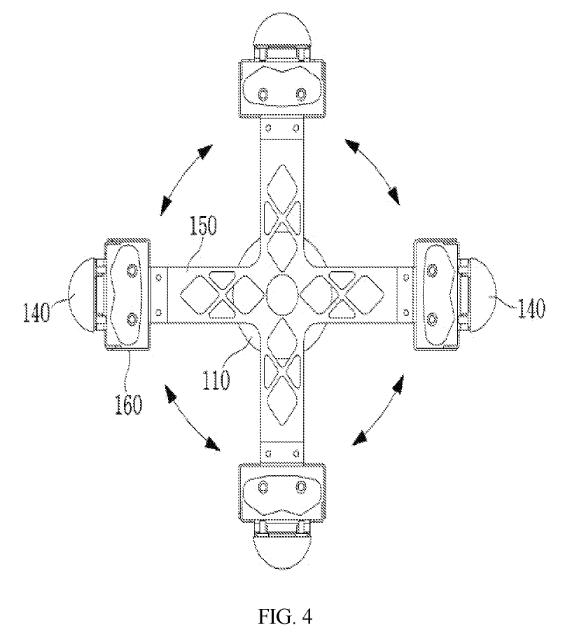

FIG. 2 is a perspective view of an active base-tracking multi-antenna system for a vessel and an offshore structure according to a first embodiment of the present invention, FIG. 3 is a partial-cut front view of the active base-tracking multi-antenna system for a vessel and an offshore structure according to the first embodiment of the present invention, and FIG. 4 is a plan view of the active base-tracking multi-antenna system for a vessel and an offshore structure according to the first embodiment of the present invention.

An active base-tracking multi-antenna system 100 for a vessel and an offshore structure according to a first embodiment of the present invention includes a fixing shaft 110, a gimbal unit 120, a panning motor 130, and antennas 140.

The fixing shaft 110, which supports the gimbal unit 120, the panning motor 130, and the antennas 140, is fixed to a fixture such as the deck of a vessel or an offshore structure.

The fixing shaft 110 may be installed at a position where the antennas 140 fixed by the fixing shaft can optimally transmit/receive communication signals to/from a base station.

The gimbal unit 120, which keeps the antennas 140 in a stable horizontal position, is mounted on the top of the fixing shaft 110.

In this embodiment, the gimbal unit 120 can keep the antennas 140 in a stable position via a universal joint using gravity without a specific controlling or actuating unit.

The gimbal unit 120 includes: a fixing bracket 121 fixed to the top of the fixing shaft 110; a Y-axial rotation support bracket 122 coupled to an X-axial hinge pin 121a on the fixing bracket 121 to freely rotate in the Y-axial direction; and an X-axial rotation support bracket 123 coupled to an Y-axial hinge pin 122a on the Y-axial rotation support bracket 122 to freely rotate in the X-axial direction.

The Y-axial direction means the front-rear direction and the X-axial direction means the left-right direction.

The panning motor 130, which is provided to adjust the azimuths of the antennas 140, is fixed to the top of the X-axial rotation support bracket 123 of the gimbal unit 120.

The operation of the gimbal unit 120 is controlled by an ACU (Antenna Control Unit) having various items of control information, including vessel information and base station information.

The antennas 140, which are provided to transmit/receive data to/from a base station on land or at sea, are connected to the panning motor 130.

The active base-tracking multi-antenna system 100 for a vessel and an offshore structure according to this embodiment of the present invention includes a rotary plate 150 disposed on a rotary shaft of the panning motor 130 and supporting the antennas 140.

In this embodiment, the rotary plate 150 supports four antennas 140 in the shape of a cross.

In this embodiment, the antennas 140 are fixed to modern brackets 160, respectively, which are individually fixed to the front, rear, left, and right of the cross-shaped rotary plate 150.

In the active base-tracking multi-antenna system 100 for a vessel and an offshore structure according to this embodiment of the present invention, the shape of the rotary plate 150 and the number of the antennas 140 can be changed within an expectable range.

That is, in the active base-tracking multi-antenna system 100 for a vessel and an offshore structure according to this embodiment of the present invention, the number of the antennas 140 may be increased or decreased to three, five, six, or eight and the shape of the rotary plate 150 may be changed to correspond to the number of the antennas 140.

Further, when the antenna 140 for a predetermined direction is not necessary, it may be possible to mount a balance member having the same weight as the antenna 140 for the direction instead of the antenna 140.

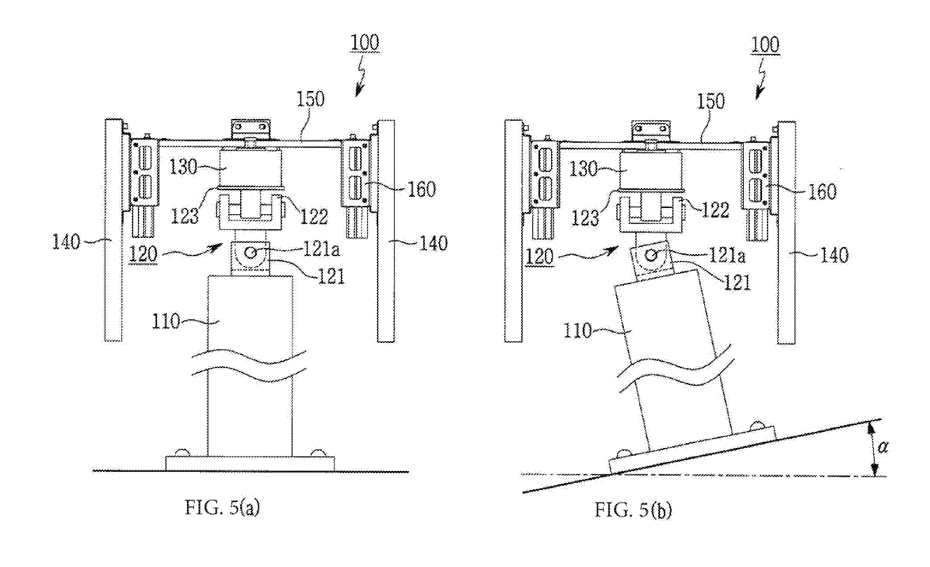

FIGS. 5a and 5b are side views showing the operation of the active base-tracking multi-antenna system for a vessel and an offshore structure according to the first embodiment of the present invention.

In the active base-tracking multi-antenna system 100 for a vessel and an offshore structure according to the first embodiment of the present invention, the antennas 140 can keep a stable horizontal position regardless of pitch and roll of a vessel or an offshore structure due to waves.

For example, even if a vessel or an offshore structure is lifted up at the front at a predetermined angle a due to waves, the fixing shaft 110 fixed to the deck of the vessel or the offshore structure and the fixing bracket 121 of the gimbal unit 120 rotate counterclockwise about the X-axial hinge pin 121a, as show in FIG. 5b, so only they are inclined at the same angle as the inclination of the vessel or the offshore structure, while the antennas 140 and the panning motor 130, and the X-axial rotation support bracket 123 and the Y-axial rotation support bracket 122 that support the weight of the rotary plate 150 are not moved; therefore, the antennas 140 and the panning motor 130 can keep a stable horizontal position.

Furthermore, for example, when a vessel or an offshore structure rolls with the left or right side lifted by waves, the fixing shaft 110 fixed to the deck of the vessel or the offshore structure, the fixing bracket 121 of the gimbal unit 120, and the Y-axial rotation support bracket 122 rotate clockwise or counterclockwise about the Y-axial hinge pin 122a, so only they are inclined at the same angle as the inclination of the vessel or the offshore structure, while the antennas 140 and the panning motor 130, and the X-axial rotation support bracket 123 supporting the weight of the rotary plate 150 are not moved; therefore, the antennas 140 and the panning motor 130 can keep a stable horizontal position.

According to the active base-tracking multi-antenna system 100 for a vessel and an offshore structure of this embodiment of the present invention, even if a vessel or an offshore structure is moved in any direction by waves, the antennas 140 and the panning motor 130, and the X-axial rotation support bracket 123 of the gimbal unit 120 supporting the weight of the rotary plate 150 are not moved, so the antennas 140, the panning motor 130, and the rotary plate 150 can keep a stable horizontal position.

Meanwhile, according to the active base-tracking multi-antenna system 100 for a vessel and an offshore structure of this embodiment of the present invention, when the azimuths of the antennas 140 communicating with a base station change while a vessel or an offshore structure is at sea, the panning motor 130 controlled by the ACU operates and rotates the rotary plate 150 and the antennas 140 fixed to the rotary plate 150 at a predetermined angle where optical communication with the base station is maintained, whereby it is possible to always connect and maintain an optimal communication link.

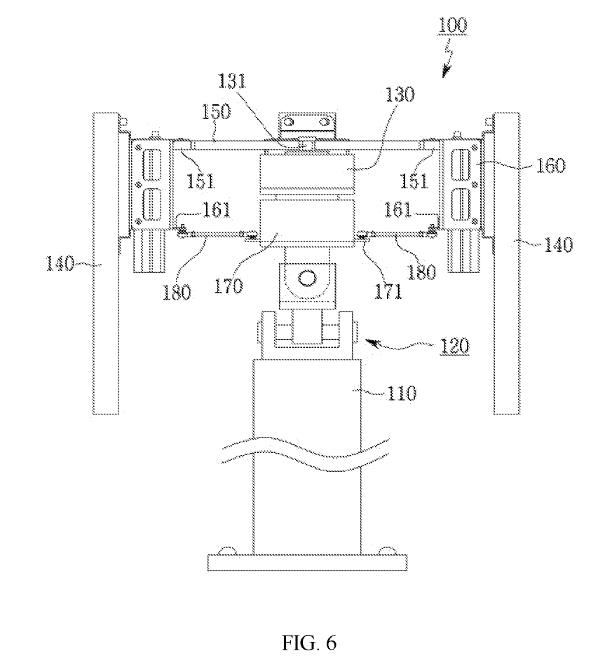

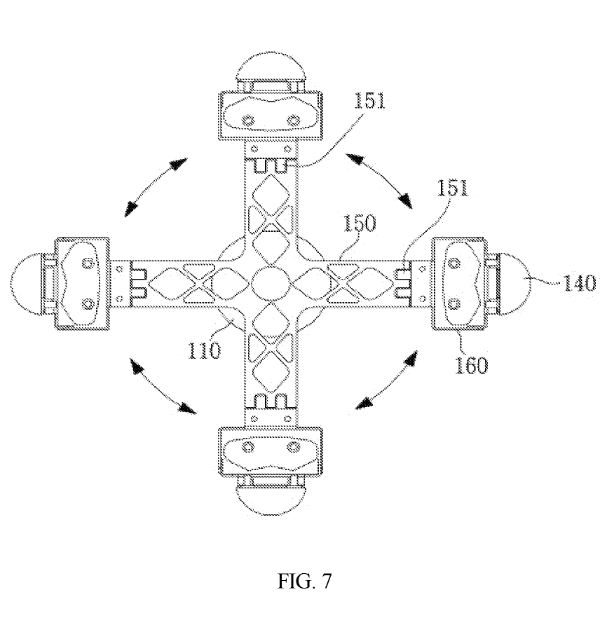

FIG. 6 is a partial-cut front view of an active base-tracking multi-antenna system for a vessel and an offshore structure according to a second embodiment of the present invention and FIG. 7 is a plan view of the active base-tracking multi-antenna system for a vessel and an offshore structure according to the second embodiment of the present invention.

The active base-tracking multi-antenna system 100 for a vessel and an offshore structure according to a second embodiment of the present invention, shown in FIGS. 6 and 7, is achieved by adding a tilting function for automatically adjusting the vertical angles of the antennas 140 in the active base-tracking multi-antenna system 100 for a vessel and an offshore structure according to the first embodiment of the present invention.

The active base-tracking multi-antenna system 100 for a vessel and an offshore structure according to the second embodiment of the present invention includes a tilting motor 170 fixed to the top of the X-axial rotation support bracket 123 of the gimbal unit 120.

The tilting motor 170 is an outer rotor motor having a rotor around the outside of a stator and has four connection flanges 171 radially extending outward from the rotor.

The operation of the tilting motor 170 is, similar to the gimbal unit 120, controlled by an ACU (Antenna Control Unit) having various items of control information, including vessel information and base station information.

In the active base-tracking multi-antenna system 100 for a vessel and an offshore structure according to the second embodiment of the present invention, tilting hinge extensions 151 are coupled to the joints, which are coupled to the antennas, of the cross-shaped rotary plate 150 to be rotatable up and down.

Further, modern brackets 160 are fixed to the tilting hinge extensions 151, respectively, and the antennas 140 are fixed to the modern brackets 160, respectively.

Further, coupling extensions 161 are formed on the inner sides at the lower ends of the modern brackets 160 and connection links 180 are disposed between the coupling extensions 161 of the modern brackets 160 and the flanges 171 of the tilting motor 170.

In the active base-tracking multi-antenna system 100 for a vessel and an offshore structure according to the second embodiment of the present invention, the panning motor 130 is disposed on the tilting motor 170 and the rotary plate 150 is disposed on the rotary shaft 131 of the panning motor 130.

In the active base-tracking multi-antenna system 100 for a vessel and an offshore structure according to the second embodiment of the present invention, the operation that the antennas 140 are kept in the stable horizontal position against movement of a vessel or an offshore structure by the gimbal unit 120 is the same as in the first embodiment.

Further, in the active base-tracking multi-antenna system 100 for a vessel and an offshore structure according to the second embodiment of the present invention, the operation that the panning motor 130 rotates the rotary plate 150 and the antennas 140 fixed to the rotary plate 150 at a predetermined angle where optimal communication with a base station is maintained to always connect and maintain an optimal connection link is also the same as in the first embodiment.

Further, in the active base-tracking multi-antenna system 100 for a vessel and an offshore structure according to the second embodiment of the present invention, it is possible to further optimize connection of the communication link by automatically adjusting the vertical angles of the antennas 140.

That is, when the vertical angles of the antennas 140, where an optimal communication link with a base station is connected while a vessel or an offshore sails, change, the ACU operates the tilting motor 170, thereby automatically adjusting the vertical angles of the antennas 140 to an optimal angle.

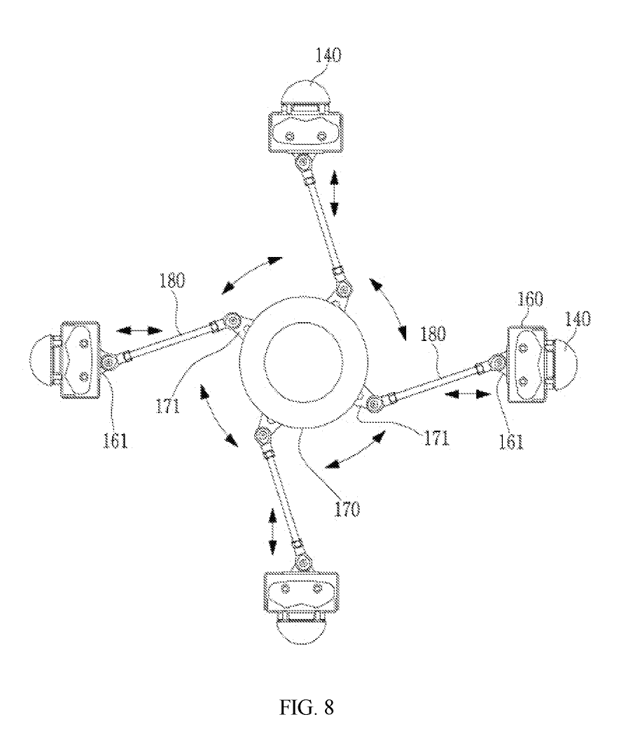

FIG. 8 is a plan view showing main parts when tilting is performed by the active base-tracking multi-antenna system for a vessel and an offshore structure according to the second embodiment of the present invention.

In the active base-tracking multi-antenna system 100 for a vessel and an offshore structure according to the second embodiment of the present invention, when the flanges 171 of the tilting motor 170 that is controlled by the ACU are rotated counterclockwise in a plan view, the connection links 180 push outward the lower portions of the modern brackets 160 and the antennas 140, so the upper portions of the antennas 140 are rotated inward around the tilting hinge extensions 151 and accordingly the vertical angle of the antennas 140 is adjusted such that the angles between the antennas 140 and the horizon increase.

Further, when the flanges 171 of the tilting motor 170 are rotated clockwise in a plan view, the connection links 180 pull inward the lower portions of the modern bracket 160 and the antennas 140, so the upper portions of the antennas 140 are rotated outward around the hinged points of the tilting hinge extensions 151 and accordingly, the vertical angles of the antennas 140 are adjusted such that the angles between the antennas 140 and the horizon decrease.

As described above, the active base-tracking multi-antenna system 100 for a vessel and an offshore structure according to the second embodiment of the present invention can keep the antennas 140 in the stable horizontal position regardless of movement of a vessel or an offshore structure due to waves. Further, it is possible to adjust the azimuths and vertical angles of the antennas 140 communicating with a base station such that an optical communication link can be connected and maintained by controlling the panning motor 130 and the tilting motor 170.

<Active Base-Tracking Antenna System for a Vessel and an Offshore Structure>

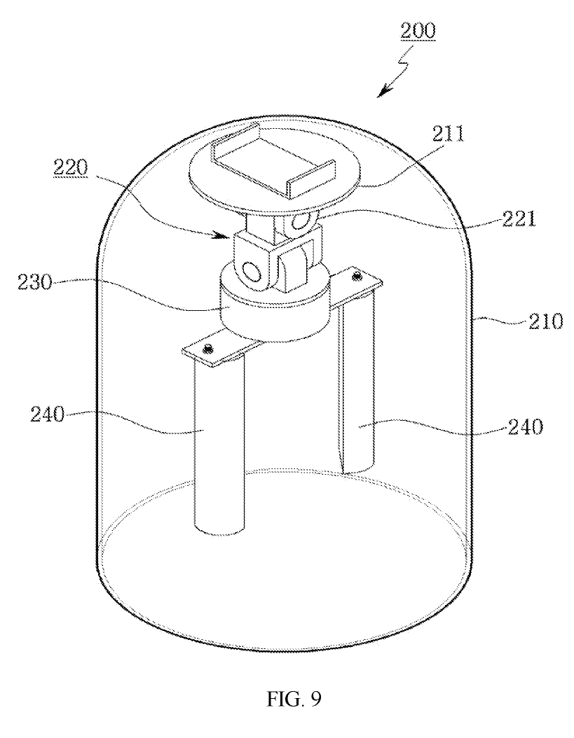

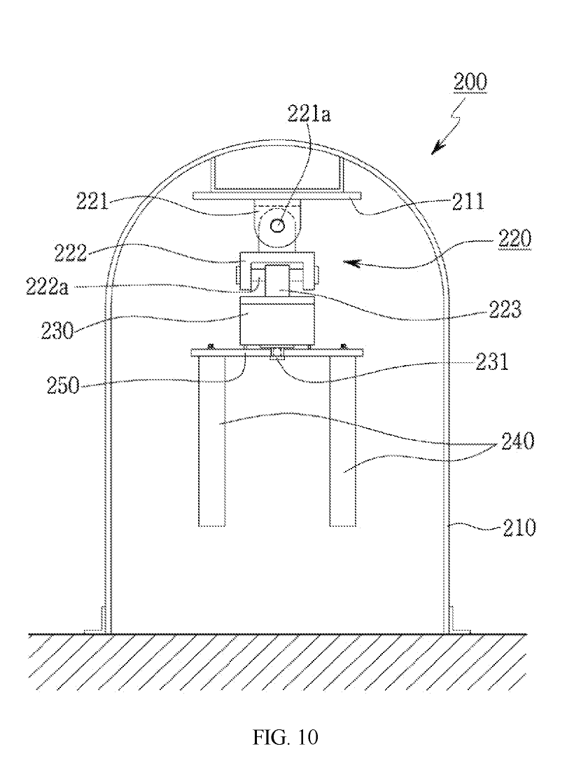

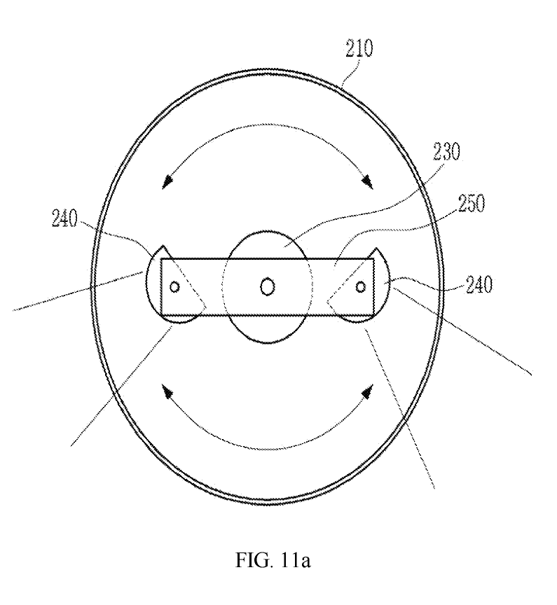

FIG. 9 is a perspective view of an active base-tracking antenna system for a vessel and an offshore structure according to a first embodiment of the present invention and FIG. 10 is a front view of the active base-tracking antenna system for a vessel and an offshore structure according to the first embodiment of the present invention.

The active base-tracking antenna system 200 for a vessel and an offshore structure according to the first embodiment of the present invention includes a protective case 210, a gimbal unit 220, a panning motor 230, and a pair of antennas 240.

The protective case 210, which supports the gimbal unit 220, the panning motor 230, and the antennas 240, is fixed to a fixture such as a mast or the deck of a vessel or an offshore structure.

The protective case 210 has a shape of which the upper part is formed in a semispherical shape and the lower part is formed in a cylindrical shape.

A support plate 211 that supports the gimbal unit 220 is disposed at an upper portion in the protective case 210.

The gimbal unit 220, which keeps the antennas 240 in a stable position, is disposed at the lower end of the support plate 211 of the protective case 210.

In the active base-tracking antenna system 200 for a vessel and an offshore structure according to the first embodiment of the present invention, the gimbal unit 220 keeps the antennas 240 in a stable position by way of a universal joint using gravity without a specific controlling or actuating unit.

The gimbal unit 220 includes: a fixing bracket 221 fixed to the bottom of the support plate 211 of the protective case; a Y-axial rotation support bracket 222 coupled to an X-axial hinge pin 221a of the fixing bracket 221 to freely rotate in the Y-axial direction; and an X-axial rotation support bracket 223 coupled to an Y-axial hinge pin 222a of the Y-axial rotation support bracket 222 to freely rotate in the X-axial direction.

The Y-axial direction means the front-rear direction and the X-axial direction means the left-right direction.

The panning motor 230, which is provided to adjust the azimuths of the antennas 240, is fixed to the bottom of the X-axial rotation support bracket 223 of the gimbal unit 220.

The operation of the gimbal unit 220 is controlled by an ACU (Antenna Control Unit) having various items of control information, including vessel information and base station information.

The antennas 240, which are provided to transmit/receive data to/from a base station on land or at sea, are connected to the panning motor 130.

In the active base-tracking antenna system 200 for a vessel and an offshore structure according to the first embodiment of the present invention, the antennas 240 are directional antennas that perform communication through the front.

The active base-tracking antenna system 200 for a vessel and an offshore structure according to the first embodiment of the present invention includes a rotary plate 250 fixed to a rotary shaft 231 of the panning motor 230 and holding the antennas 240.

In the first embodiment of the present invention, the rotary plate 250 is formed in the shape of a straight line with the center connected to the panning motor 230 and with the antennas 240 coupled to both ends of the bottom, respectively.

The connection angle of the antennas 240 coupled to both ends of the bottom of the rotary plate 250 may be in the range of 30°-60° and may be adjusted, depending on the shapes of a vessel or an offshore structure and other conditions.

In the active base-tracking antenna system 200 for a vessel and an offshore structure according to the first embodiment of the present invention, when one of the antennas 240 is not needed, it may be possible to mount a balance member having the same weight as the antenna 240 without installing the antenna 240 in the direction.

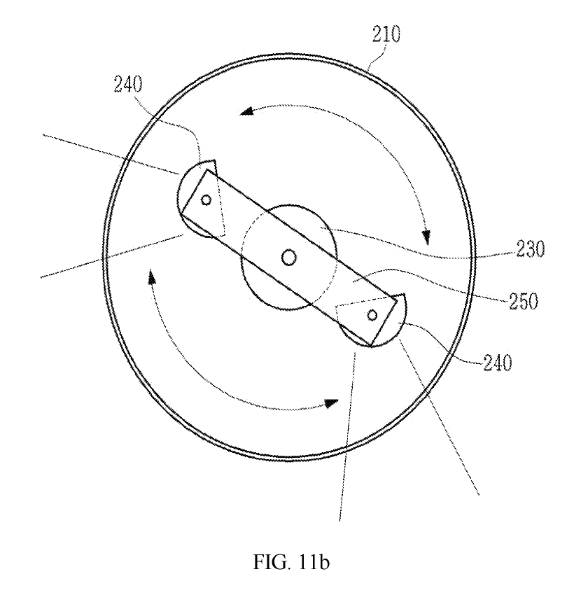

FIGS. 11a and 11b are plan views showing operation of a panning motor of the active base-tracking antenna system for a vessel and an offshore structure according to the first embodiment of the present invention.

According to the active base-tracking antenna system 200 for a vessel and an offshore structure according to the first embodiment of the present invention, when the azimuths of the antennas 240 communicating with a base station change while a vessel or an offshore structure sails, as shown in FIGS. 11a and 11b, the panning motor 130 controlled by an ACU operates and rotates the rotary plate 150 and the antennas 140 fixed to the rotary plate 250 at a predetermined angle where optical communication with the base station is maintained, whereby it is possible to always connect and maintain an optimal communication link.

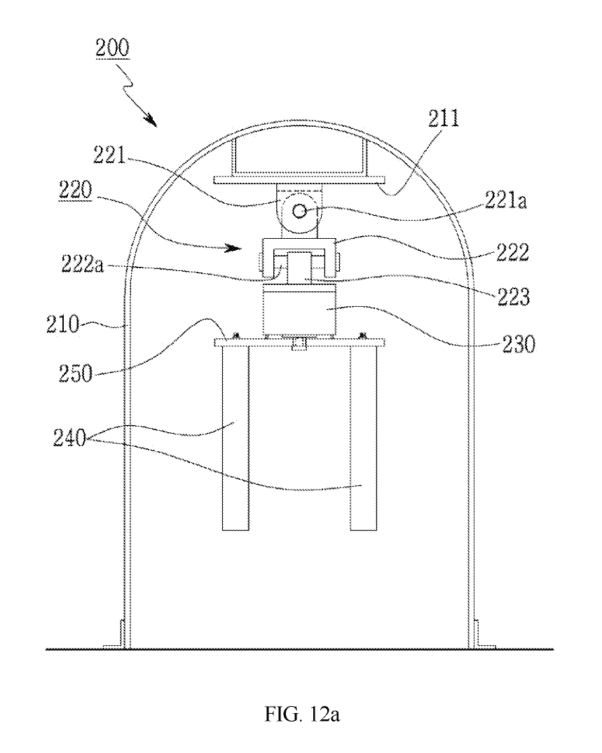

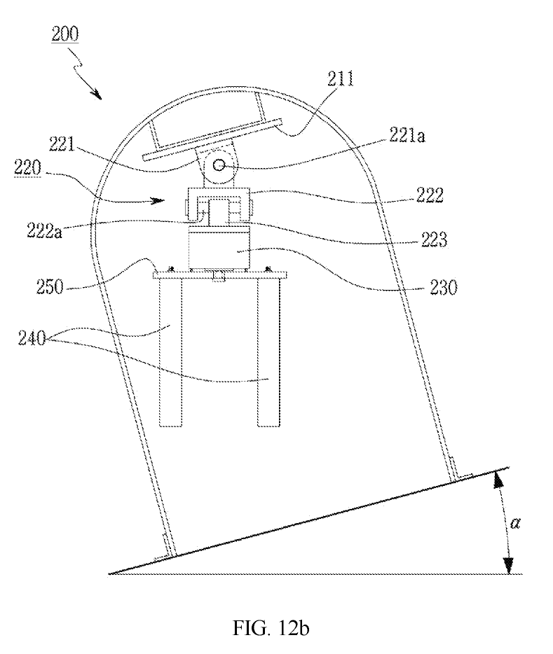

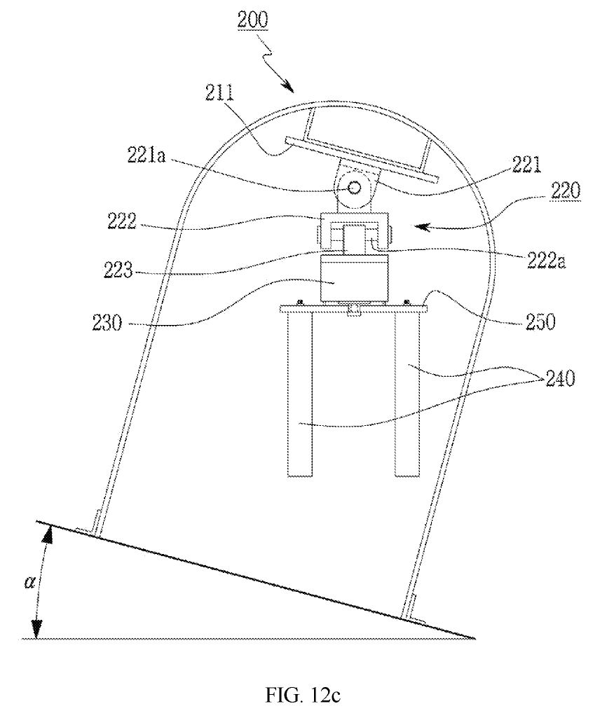

FIGS. 12a and 12c are side views showing operation of a gimbal unit of the active base-tracking antenna system for a vessel and an offshore structure according to the first embodiment of the present invention;

In the active base-tracking antenna system 200 for a vessel and an offshore structure according to the first embodiment of the present invention, the antennas 240 can keep a stable horizontal position regardless of pitch and roll of a vessel or an offshore structure due to waves.

For example, even if a vessel or an offshore structure is lifted up at the front at a predetermined angle a due to waves, as show in FIG. 12b, the protective case 210 and the support bracket 211, which are fixed to a fixture on the vessel or the offshore structure, and the fixing bracket 221 of the gimbal unit 220 rotate counterclockwise about the X-axial hinge pin 221a, so only they are inclined at the same angle as the inclination of the vessel or the offshore structure, while the antennas 240 and the panning motor 230, and the X-axial rotation support bracket 223 and the Y-axial rotation support bracket 222 that support the weight of the rotary plate 250 are not moved; therefore, the antennas 240 and the panning motor 230 can keep a stable position regardless of the movement of the vessel or the offshore structure.

For example, even if a vessel or an offshore structure is lifted up at the rear at a predetermined angle a due to waves, as show in FIG. 12c, the protective case 210 and the support bracket 211, which are fixed to a fixture on the vessel or the offshore structure, and the fixing bracket 221 of the gimbal unit 220 rotate clockwise about the X-axial hinge pin 221a, so only they are inclined at the same angle as the inclination of the vessel or the offshore structure, while the antennas 240 and the panning motor 230, and the X-axial rotation support bracket 223 and the Y-axial rotation support bracket 222 that support the weight of the rotary plate 250 are not moved, similar to the case when the vessel or the offshore structure is lifted up at the front; therefore, the antennas 240 and the panning motor 230 can keep a stable position regardless of the movement of the vessel or the offshore structure.

Further, for example, when a vessel or an offshore structure rolls with the left or right side lifted by waves, the protective case 210 fixed to a fixture on the vessel or the offshore structure, the fixing bracket 221 of the gimbal unit 220, and the Y-axial rotation support bracket 222 rotate clockwise or counterclockwise about the Y-axial hinge pin 222a, so only they are inclined at the same angle as the inclination of the vessel or the offshore structure, while the antennas 240 and the panning motor 230, and the X-axial rotation support bracket 223 supporting the weight of the rotary plate 250 are not moved; therefore, the antennas 240 and the panning motor 230 can keep a stable position regardless of the rolling of the vessel or the offshore structure.

According to the active base-tracking antenna system 200 for a vessel and an offshore structure of the first embodiment of the present invention, even if a vessel or an offshore structure is moved in any direction by waves, the antennas 240 and the panning motor 230, and the X-axial rotation support bracket 223 of the gimbal unit 220 supporting the weight of the rotary plate 250 are not moved, so the antennas 240, the panning motor 230, and the rotary plate 250 can keep a stable position.

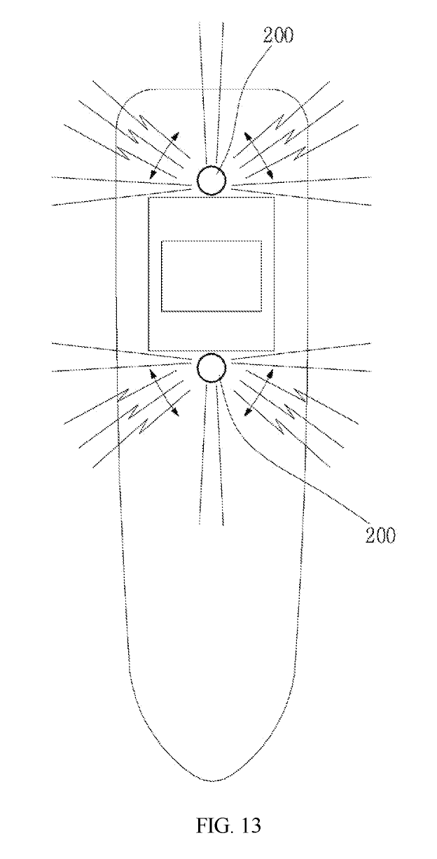

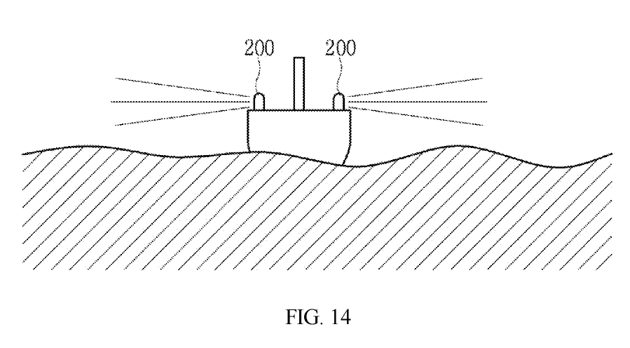

FIGS. 13 and 14 are exemplar views of installation of the active base-tracking antenna system for a vessel and an offshore structure according to the first embodiment of the present invention.

Since the active base-tracking antenna system 200 for a vessel and an offshore structure of the first embodiment of the present invention uses a pair of directional antennas 240 that perform communication through the fronts, it may be possible to arrange the pair of antennas in the front-rear direction on a vessel or an offshore structure as in FIG. 13 or in the left-right direction on a vessel or an offshore structure so that communication can be performed in all directions as in FIG. 13.

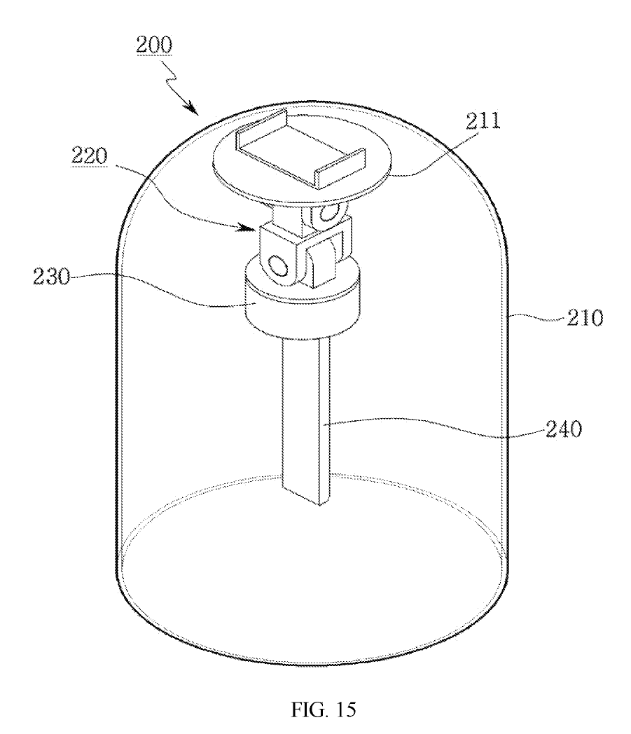

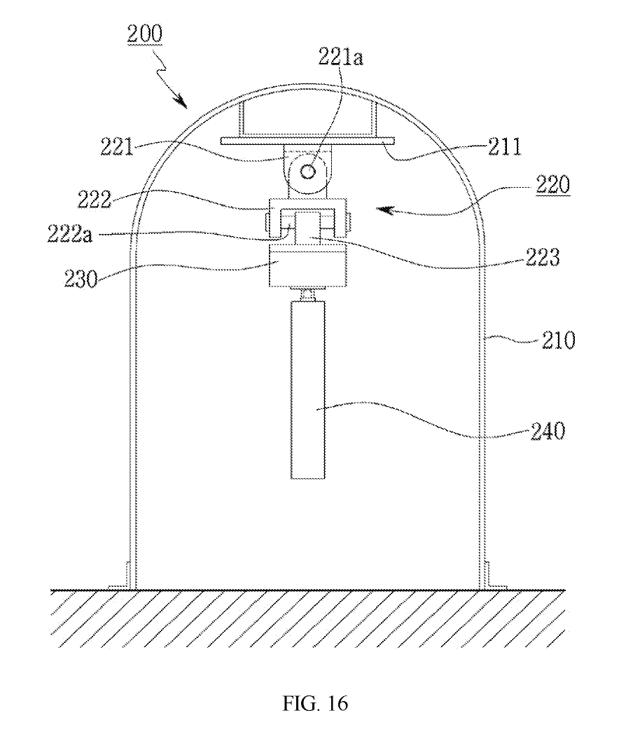

FIG. 15 is a perspective view of an active base-tracking antenna system for a vessel and an offshore structure according to a second embodiment of the present invention and FIG. 16 is a front view of the active base-tracking antenna system for a vessel and an offshore structure according to the second embodiment of the present invention.

The active base-tracking antenna system 200 for a vessel and an offshore structure according to the second embodiment of the present invention includes one directional antenna 240 directly coupled to a panning motor 230 without the rotary plate 250.

Since the active base-tracking antenna system 200 for a vessel and an offshore structure according to the second embodiment of the present invention uses only one directional antenna 240, it is possible to reduce the capacity of the panning motor 230 and more efficiently adjust the azimuth.

In the active base-tracking antenna system 200 for a vessel and an offshore structure according to the second embodiment of the present invention, the operation of the antenna 240 keeping a stable position through the gimbal unit 220 when a vessel or an offshore structure fluctuates is the same as that in the first embodiment.

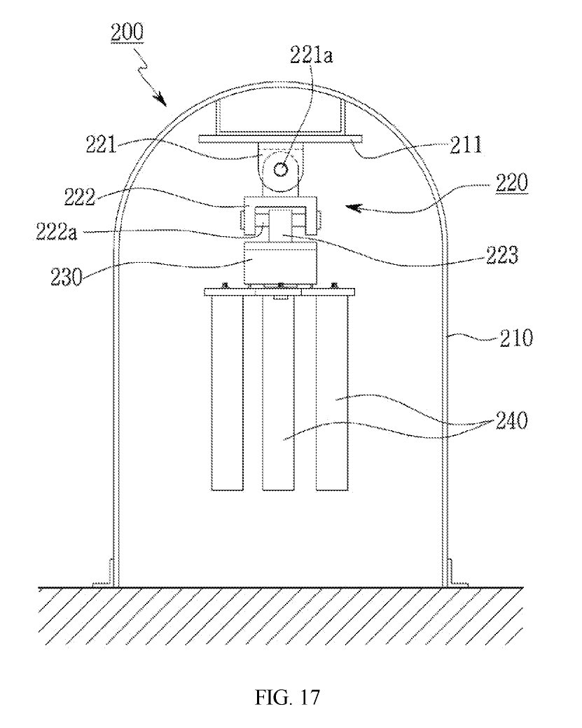

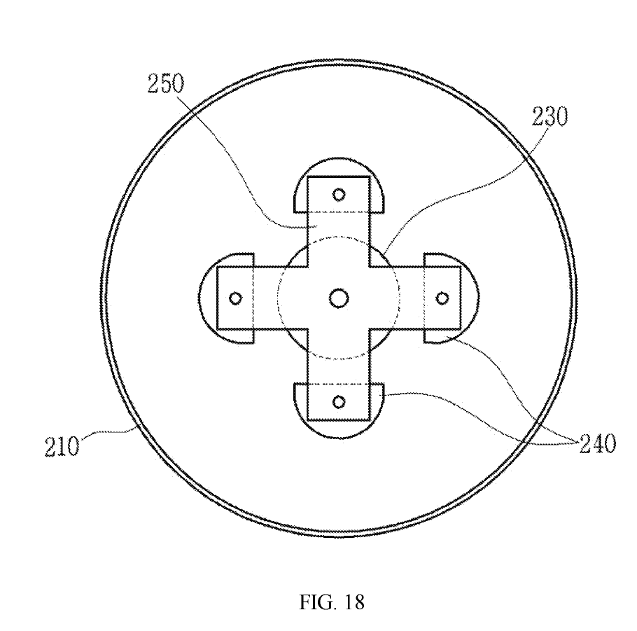

FIG. 17 is a front view of an active base-tracking antenna system for a vessel and an offshore structure according to a third embodiment of the present invention and FIG. 18 is a plan view of the active base-tracking antenna system for a vessel and an offshore structure according to the third embodiment of the present invention.

In the active base-tracking antenna system 200 for a vessel and an offshore structure according to the third embodiment of the present invention, four directional antennas 240 are coupled to a panning motor 230 through a cross-shaped rotary plate 250.

Since the active base-tracking antenna system 200 for a vessel and an offshore structure according to a third embodiment of the present invention can communicate with a base station using any one of four directional antennas 240, the rotational range and the azimuth range of the panning motor 230 may be reduced, so that tracking a base station is easier.

Further, in the active base-tracking antenna system 200 for a vessel and an offshore structure according to a third embodiment of the present invention, four directional antennas 240 are circumferentially arranged on the bottom of the panning motor 230, so it is easy to fix the center of gravity. Accordingly, it is possible to keep the antennas 240 in a more stable position through the gimbal unit 220 when a vessel or an offshore structure fluctuates.

In the active base-tracking antenna system 200 for a vessel and an offshore structure according to the present invention, the number of the antennas 240 may be changed within an expectable range.

In the active base-tracking antenna system 200 for a vessel and an offshore structure according to the present invention, the number of the antennas 240 may be increased or decreased to three, five, six, or eight and the shape of the rotary plate 250 may be changed to correspond to the number of the antennas 240.

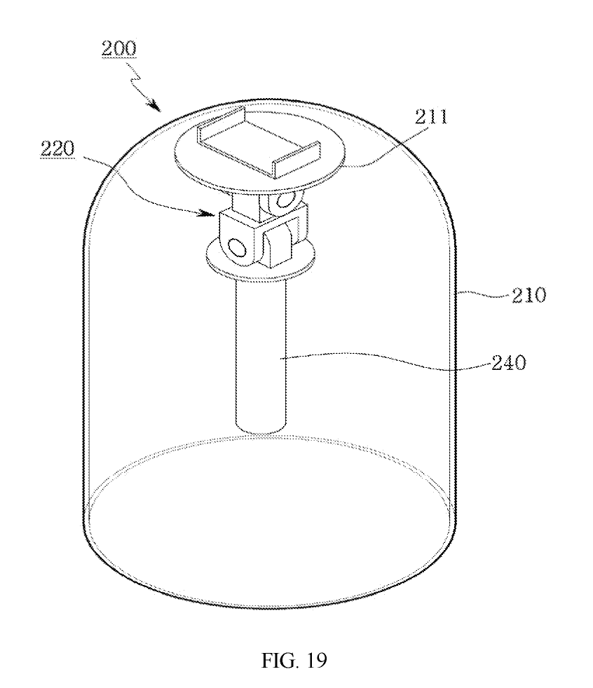

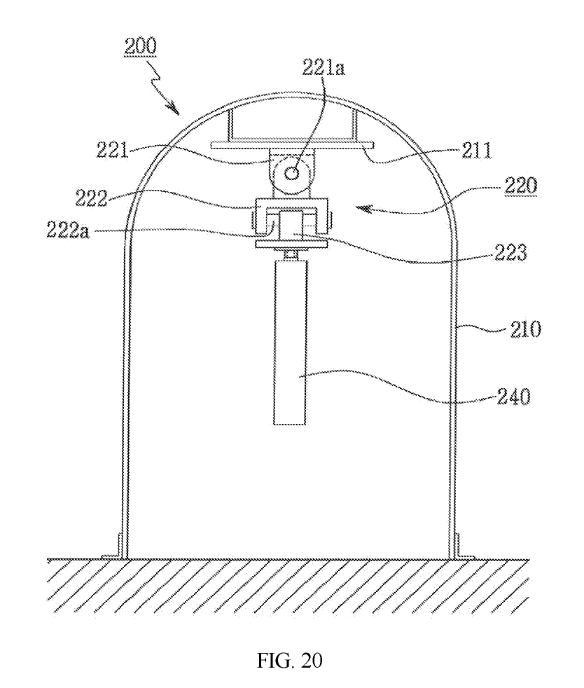

FIG. 19 is a perspective view of an active base-tracking antenna system for a vessel and an offshore structure according to a fourth embodiment of the present invention and FIG. 20 is a front view of the active base-tracking antenna system for a vessel and an offshore structure according to the fourth embodiment of the present invention.

In the active base-tracking antenna system 200 for a vessel and an offshore structure according to the fourth embodiment of the present invention, a non-directional antenna 240 that can perform communication in all directions is directly coupled to a gimbal unit 220.

In the active base-tracking antenna system 200 for a vessel and an offshore structure according to the fourth embodiment of the present invention, the panning motor 230 and the rotary plate 250 for adjusting an azimuth are not used, so it is possible to simplify the entire system.

As described above, the active base-tracking multi-antenna systems 200 for a vessel and an offshore structure according to the present invention can keep the antennas 240 in a stable position regardless of fluctuation of a vessel or an offshore structure due to waves through the gimbal unit 220.

Further, the active base-tracking multi-antenna systems 200 for a vessel and an offshore structure according to the present invention can adjust the azimuths of the antennas 240 that communicate with a base station so that an optimal communication link can always be connected and maintained.

Although the present invention was described in detail with reference to embodiments, it should be understood that the present invention is not limited to the embodiments and may be modified in various ways without departing from the scope of the present invention.

What is claimed is:

1. An active base-tracking multi-antenna system for a vessel and an offshore structure, the system comprising:
a fixing shaft fixed to a fixture on a vessel or an offshore structure;
a gimbal unit disposed on a top of the fixing shaft and maintaining positions of a panning motor and a plurality of antennas;
the panning motor disposed on the gimbal unit and simultaneously rotating the antennas in a left-right direction; and
the antennas connected to the panning motor.

2. The system of claim 1, further comprising a rotary plate fixed to a rotary shaft of the panning motor and supporting the antennas.

3. The system of claim 1, wherein the gimbal unit keeps the antennas in a stable position in a way of a universal joint using gravity without a specific controlling or actuating unit.

4. The system of claim 3, wherein the gimbal unit includes:
a fixing bracket fixed to the top of the fixing shaft;
a Y-axial rotation support bracket coupled to an X-axial hinge pin on the fixing bracket to freely rotate in a Y-axial direction; and
an X-axial rotation support bracket coupled to a Y-axial hinge pin on the Y-axial rotation support bracket to freely rotate in an X-axial direction.

5. The system of claim 1, wherein operation of the gimbal unit is controlled by an antenna control unit (ACU) having various items of control information, including vessel information and base station information.

6. The system of claim 2, wherein there are four of the antennas, the rotary plate is formed in the shape of a cross and supports the four antennas, and
modern brackets for fixing the antennas are coupled to front, rear, left, and right sides of the rotary plate, respectively.

7. The system of claim 2, further comprising a tilting motor fixed to a top of the gimbal unit and adjusting vertical angles of the antennas.

8. The system of claim 7, wherein the panning motor is disposed on the tilting motor and the rotary plate is disposed on the rotary shaft of the panning motor.

9. The system of claim 7, wherein operation of the tilting motor is controlled by an antenna control unit (ACU) having various items of control information, including vessel information and base station information.

10. The system of claim 7, wherein the tilting motor is an outer rotor motor having a rotor around an outside of a stator,
a plurality of flanges radially extending outward is formed around an outside of the rotor,
tilting hinge extensions are coupled to joints, which are coupled to the antennas, of the rotary plate to be rotatable up and down,
modern brackets are fixed to the tilting hinge extensions, respectively,
the antennas are fixed to the modern brackets, respectively, and
connection links are disposed between coupling extensions on inner sides of the modern brackets and the flanges of the tilting motor.

11. An active base-tracking antenna system for a vessel and an offshore structure, the system comprising:
a protective case fixed to a fixture on a vessel or an offshore structure;
a gimbal unit disposed at an upper portion in the protective case and maintaining a position of an antenna; and
the antenna disposed under the gimbal unit.

12. The system of claim 11, further comprising a panning motor disposed under the gimbal unit,
wherein the antenna is coupled to the panning motor.

13. The system of claim 12, wherein a rotary plate is disposed on a rotary shaft of the panning motor and the antenna is fixed to the rotary plate.

14. The system of claim 11, wherein the gimbal unit keeps the antenna in a stable position by means of a universal joint using gravity without a specific controlling or actuating unit.

15. The system of claim 14, wherein the gimbal unit includes:
a fixing bracket fixed at the upper portion in the protective case;
a Y-axial rotation support bracket coupled to an X-axial hinge pin of the fixing bracket to freely rotate in a Y-axial direction; and
an X-axial rotation support bracket coupled to a Y-axial hinge pin of the Y-axial rotation support bracket to freely rotate in an X-axial direction.

16. The system of claim 12, wherein operation of the panning motor is controlled by an antenna control unit (ACU) having various items of control information, including vessel information and base station information.

17. The system of claim 13, wherein the rotary plate is formed in a straight line shape, and
the antenna is disposed at both ends of a bottom of the rotary plate.

18. The system of claim 13, wherein the rotary plate is formed in a cross shape, and
the antenna is disposed at front, rear, left, and right sides of a bottom of the rotary plate.

19. The system of claim 17, wherein the antenna is a directional antenna.
